(19) United States
(12) Patent Application Publication
(10) Pub. No.: US 2009/0077213 A1
(43) Pub. Date: Mar. 19, 2009

(54) System and Method for Advising Network Solutions

(76) Inventors: Richard Nedwich, Monte Sereno, CA (US); William Sakoda, East Setauket, NY (US); Manju Mahishi, San Jose, CA (US)

Correspondence Address: Fay Kaplun & Marcin, LLP/ Motorola, 150 Broadway Suite 702, New York, NY, 10038, US

(21) Appl. No.: 11/856,488

(22) Filed: Sep. 17, 2007

(51) Int. Cl. G06F 15/173

(52) U.S. Cl. 709/223

(57) ABSTRACT

A system and method advises network solutions. The method comprises receiving a request for a service to be implemented on a network, determining at least one solution to implement the service utilizing existing network components of the network, and presenting the at least one solution to a user. The system comprises a database storing network data for a plurality of network components in a network, an input module receiving an input indicating a requested new service for the network, a solution module searching the network data and determining at least one solution to implement the new service on the network, and an output module presenting the at least one solution to a user.

### FIELD OF THE INVENTION

The present invention relates generally to a system and method for advising network solutions. Specifically, services are found and presented so that that may be implemented using components of a network or by adding components to the network.

### BACKGROUND

In enterprise mobility sales situations, a customer typically first implements a mobile data-centric “line of business” application through deployment of wireless local area networks and/or wireless enabled mobile computers and management services platforms. Subsequently, the customer often seeks new ways to leverage the investment by extending the use of the existing mobility equipment to support new solutions. Network consultants or solution domain experts may be hired to determine ways of implementing the new solutions. However, as the network becomes more complex, expenses incurred to implement the new solutions may increase rapidly. Furthermore, it is often difficult to ascertain which new solutions best match the existing equipment and customer needs. Thus, in order to implement the new solutions, additional components may unnecessarily be included in the network, thereby increasing the network complexity and/or operating expense.

### SUMMARY OF THE INVENTION

The present invention relates to a method for advising network solutions. The method comprises receiving a request for a service to be implemented on a network, determining at least one solution to implement the service utilizing existing network components of the network, and presenting the at least one solution to a user.

### DESCRIPTION OF THE DRAWINGS

FIG. 1 shows components of a network according to an exemplary embodiment of the present invention.

FIG. 2 shows a method for advising network solutions according to an exemplary embodiment of the present invention.

### DETAILED DESCRIPTION

The exemplary embodiments of the present invention may be further understood with reference to the following description and the appended drawings, wherein like elements are referred to with the same reference numerals. The exemplary embodiments of the present invention describe a system and method for advising network solutions. Specifically, a management services platform (MSP) implements a network solutions advisor (NSA) to determine if a desired service solution is possible and further determine details for incorporating the desired service into the network. The MSP, the network, and the NSA will be discussed in more detail below.

In a wireless switch architecture, a wireless switch controller may mediate data flow between a wired backbone and wireless access points. The switch controller may be capable of inspecting data packets as they are received, determining the source and destination device of the packet, and forwarding the packet appropriately. As will be discussed in detail below, multiple servers may be connected to the switch. The different types of servers may control a different aspect such as a functionality that the network is capable of performing. The switch may further be connected to components that extend an operating area of the network. Thus, the switch may serve as a central component of the network. While the exemplary embodiments of the present invention are described with reference to a wireless switched network, those skilled in the art will understand that the exemplary embodiments may be implemented on any type of wireless network.

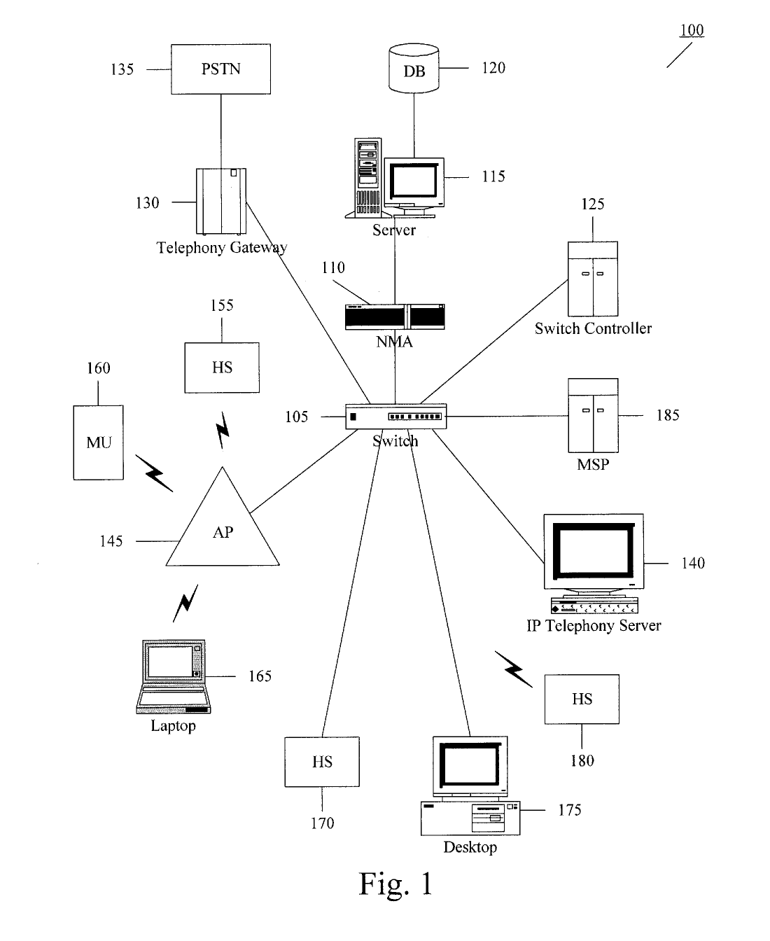

FIG. 1 shows components of a network 100 according to an exemplary embodiment of the present invention. The network 100 may be a wireless switched network. Thus, a central component of the network 100 may be a switch 105. A server 115 may be responsible for maintenance of at least a portion of the network 100. The server 115 may be connected to a database 120. A network management arrangement (NMA) 110 may be connected to the server 115. The NMA 110 may further be connected to the switch 105. As illustrated, the NMA 110 may be disposed between a data path of the switch 105 and the server 115. A switch controller 125 may be connected to the switch 105. The switch controller 125 may be responsible for a performance of the switch 105. For example, the switch controller 125 may provide the switch 105 with instructions on the different routing of data.

The network 100 may include a telephony gateway 130 and an internet protocol (IP) telephony server 140. The telephony gateway 130 may provide the network 100 with access to an analog telephone system (i.e., land lines). For example, the telephony gateway 130 may connect the network 100 to a public switched telephone network (PSTN) 135. The IP telephony server 140 may provide the network 100 with IP telephony functionalities. For example, the IP telephony functionalities may include digital signals to be transmitted to IP telephones that include data such as a caller identification, a time stamp, etc. The IP telephony server 140 may function substantially similar to the server 115 for another portion of the network 100. That is, the IP telephony server 140 may illustrate that at least two servers may be connected to the switch 105. It should be noted that the IP telephony server 140 may include a plurality of IP telephones connected thereto. It should be noted that the telephony gateway 130 may be included as part of the telephony server 140.

The operating area of the network 100 may be expanded using, for example, access points (APs). For example, the network 100 may include an AP 145. The AP 145 may be connected to the switch 105. Thus, any exchange of data may be routed to and from the switch 105 to any devices connected to the AP 145. Because the network 100 utilizes the switch 105, the AP 145 may be thin APs that are limited in the functionalities ordinarily available with conventional APs (e.g., most functions are performed by the switch). The AP 145 may be a wireless AP, thereby enabling a wireless communication of end user devices with the network 100. It should be noted that the network 100 may include additional APs to further expand the operating area of the network 100.

End user devices may be disposed within any operating area of the network 100. For example, the network 100 may include an operating area available by the switch 105. That is, the switch 105 may include a substantially radial expansion in which an end user device may wirelessly connect. As illustrated, a handset (HS) 180 is wireless connected to the switch 105. Furthermore, the switch 105 may be equipped with ports to enable a wired connection to end user devices. As illustrated, an HS 170 and a desktop 175 are connected to the network 100 through a wired connection to the switch 105. In another example, the network 100 may include additional operating areas available by the AP 145 (i.e., the overall operating area is increased beyond the operating area only available through the switch 105). The AP 145 may also include a substantially radial expansion in which end user devices may wirelessly connect. As illustrated, an HS 155, a mobile unit (MU) 160, and a laptop 165 may be wirelessly connected to the AP 145, thereby being connected to the network 100.

It should be noted that the NMA 110 disposed between the server 115 and the switch 105 is only exemplary. Those skilled in the art will understand that the server 115 may be directly connected to the switch 105. It should also be noted that the use of the NMA 110 is only exemplary. Those skilled in the art will understand that depending on the size of the network 100, a plurality of NMAs 110 may be disposed or the network 100 may not utilize the NMA 110. It should further be noted that the switch controller 125 being a separate component of the network 100 is only exemplary. Those skilled in the art will understand that the switch controller 125 may be incorporated into the switch 105. Thus, the switch controller 125 may be equipped with all the necessary functionalities. In addition, it should be noted that, because the network 100 may be a wireless switched network, all the components may be connected using one of a wired or wireless connection. For example, the NMA 110 may be wirelessly connected to the switch 105 and the server 115.

The management services platform (MSP) 185 may be responsible for monitoring and management of the network 100. For example, the network monitoring function may include the MSP 185 receiving values for the network parameters and/or network device parameters such as packet flow, battery level, etc. The values may be dynamic reports of current values from devices and/or threshold values indicating acceptable performance limits. The network management function may include taking corrective action when the parameter values indicate a problem such as the values falling outside programmed tolerances, provisioning of software of network devices, etc. The MSP 185 may be, for example, a software component implemented on a hardware device such as a server or network appliance. The MSP 185 may further include a database of the services and/or equipment available on the network 100. The database may be specific to the network 100. That is, the database may be customized to the existing components of the network 100. The information may be preloaded into the database when the initial network is installed. In addition, as new services and/or equipment are added to the network, the information may be added to the database. In a further example, the MSP 185 may have the ability to automatically detect and/or receive information from connected network devices in order to populate or further populate the database.

In this exemplary embodiment, the NSA is implemented as a component or module of the MSP 185. The NSA may use the database to perform the exemplary functionality. However, the NSA may also be implemented in a different component or as a stand-alone component. In addition, the described database may also be implemented in a different network component. Thus, when a service is requested, the NSA may locate the service in the database and forward an associated data path to the switch controller 125 which may instruct the switch 105 in routing the data in accordance with the implemented service. It should also be noted that the MSP 185 being disposed as a separate component of the network 100 is only exemplary. The MSP 185 may be embodied as part of other network components such as the switch 105, the NMA 110, the server 115, the switch controller 125, etc.

According to the exemplary embodiments of the present invention, the NSA may further be equipped to determine if a requested service is available. The network 100 may include a set of services and may further be utilized to accommodate other services. Thus, when a user, a system administrator, etc. requests a new service, the NSA may determine the plausibility of the new service. The NSA may be a software utility that acts as a network services wizard. The database described above may be used in conjunction with the software utility. The database may further include a network map with the various components existing in the network 100. The network map may indicate data paths that may be established between the various components of the network 100.

The NSA may include a display that receives an input relating to the new service. The NSA may utilize the data in the database to automatically data poll through network interrogation and look-up. The new service may be referenced with a policy application to determine whether the new service is allowable. If allowed, the NSA may determine if the new service may be accommodated with the existing components of the network 100. A report may be generated indicating whether the new service is plausible or if the new service is only possible with additional components. The report may also include various ways of accomplishing the new service, thereby giving the user, system administrator, etc. an option as to executing the new service. In another embodiment, additional inputs may be received to automatically implement a solution from a plurality of possible solutions. For example, the additional inputs may relate to a speed, a cost, a bandwidth, etc.

In a first exemplary embodiment of the NSA, a system administrator may desire to enable end user devices to communicate with users of the PSTN 135. For example, the network 100 may be enabled to allow the end user devices (e.g., the HSs 155, 170, 180, the MU 160, the laptop 165, and the desktop 175) disposed within the operating area of the network 100 to communicate amongst each other. That is, the HS 155 may communicate with the HS 170. Furthermore, the network 100 may be enabled to allow IP telephones (e.g., connected to the IP telephony server 140) to communicate with users of the PSTN 135 (e.g., via the telephony gateway 130). The system administrator may input the new service into the NSA indicating that end user devices may also communicate with users of the PSTN 135. The NSA may determine that a solution exists to enable this service. That is, data exchanged between an end user device to the AP to the switch may be routed to the telephony gateway 130 which forwards the data to the PSTN 135 and a respective user. The NSA may present this solution to the system administrator who then determines whether to allow implementation. As discussed above, the new service may be referenced to a policy application. For example, if the end user devices are designed for a virtual private network (VPN) so that communications are confidential and only allowed between other end user devices disposed in the network 100, the policy application may indicate that the new service, though available for implementation, is not allowed.

In a second exemplary embodiment of the NSA, the system administrator may desire to enable a voice communication between an HS and an IP telephone. The IP telephone may be equipped with further functionalities such as caller identification, a time stamp, etc. Thus, the voice communication may also include other data. The IP telephones may include a display in which a user may read the other data. The system administrator may input the new service into the NSA indicating that voice communications may include the other data when an incoming call to the IP telephone is from an HS of the network 100. The NSA may determine that the IP telephony server 140 may include a functionality that ascertains the other data. However, the NSA may also determine that the functionality is currently deactivated. Therefore, if activated, the other data from an HS may be forwarded to the AP, then to the switch 105, then to the IP telephony server 140 where the other data is ascertained, and sent to the IP telephone to be viewed on the display. The NSA may further determine that the server 115 may include a functionality that performs a substantially similar function and is currently activated. Thus, the other data from the HS may be forwarded to the AP, then to the switch 105, then to the server 115, the other data being ascertained at the server 115, the other data sent back to the switch 105, then to the IP telephony server 140, and viewed on the display of the IP telephone. Other components such as the NMA 110 may also perform this functionality. Thus, the NSA may present the various solutions to the system administrator along with other pertinent information relating to each solution such as a transmit speed, a total time to send, a bandwidth, etc. In another embodiment, the NSA may prompt the user to input a rating to indicate a most important feature to take precedence in determining implementation of solutions. It should be noted that this new service may also be referenced with the policy application.

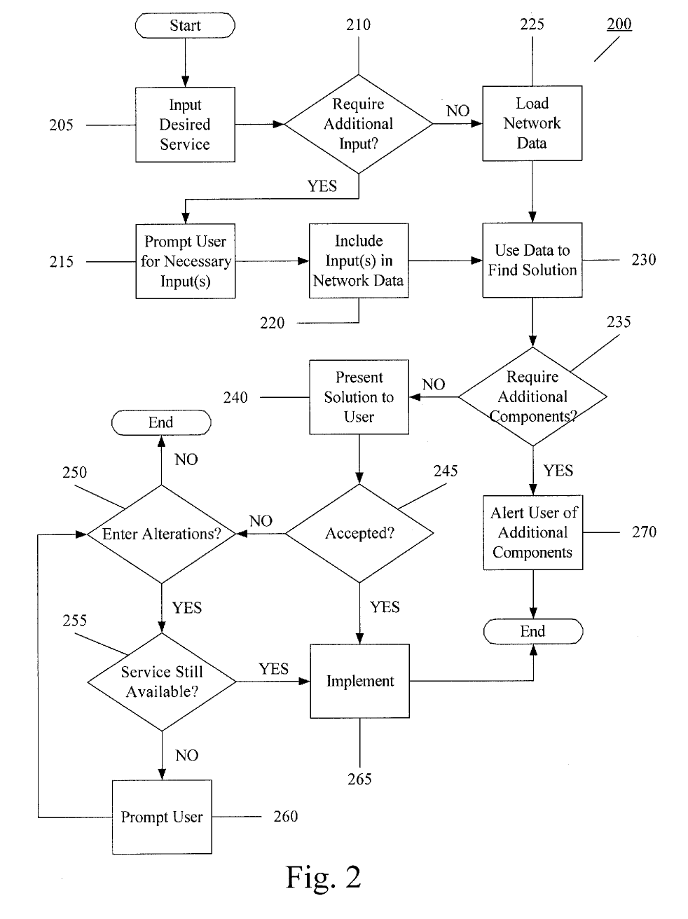

It should be noted that the above examples illustrate a simplified determination of potential solutions offered by the NSA. As will be described in further detail below, the NSA may consider additional criteria. Furthermore, as will be described in a specific example below with reference to FIG. 2, the NSA may consider service specific hardware and/or software factors in order to successfully create and implement a solution to implement the desired service.

FIG. 2 shows a method 200 for advising network solutions according to an exemplary embodiment of the present invention. The method 200 will be described with reference to the network 100 and the components therein of FIG. 1. The method 200 may be an exemplary set of steps executed by the NSA.

In step 205, a desired service is input. As discussed above, the NSA may have a display that prompts a user to enter a new service to be implemented into the network 100. A user, a system administrator, etc. may input the above described examples of enabling communications between end user devices of the network and users of the PSTN 135 and including other data with voice communications for IP telephone users. In a first exemplary embodiment, the desired service may be input manually and interpreted by the NSA. That is, a description of the service may be entered in various fields in the prompt that is deciphered by the NSA. In a second exemplary embodiment, the desired service may be selected from a list presented on the display. The list may include services that were predetermined to be implementable in the network 100. The list may also be presented in a manual for the NSA. The manual list may include a brief description so that when a service is found, a code or name may be entered into the prompt to indicate the desired service.

In step 210, a determination is made whether additional input is required. As discussed above, there are various embodiments for inputting the desired service. Therefore, it should be noted that depending on how the desired service is inputted, step 210 may be omitted. For example, if a description of the service is manually entered, additional information may be necessary to determine what exactly the desired service entails. In another example, if the desired service is selected from a list, step 210 may be bypassed as the MSP 185 may definitely know what the service entails. The determination of step 210 may also entail a network interrogation. The network interrogation may be a thorough analysis of the network configuration including the components, pathways, etc. The network interrogation may provide network data.

If step 210 determines that additional input is required, the method 200 continues to step 215. In step 215, a prompt is displayed to enter the additional input(s). In step 220, the additional input(s) is included in the network data available in the database of the MSP 185. As discussed above, the network data may include, for example, a network map, the components of the network 100, etc. If step 210 determines that additional input is not required, the method 200 continues to step 225. In step 225, the network data is loaded.

The method 200 then continues to step 230. In step 230, the network data is used to find potential solutions of implementing the desired service. As discussed above, the potential solutions may entail, for example, determining if a data pathway exists that relates to the desired service, determining if a component of the network 100 includes a necessary functionality to execute the desired service, etc. Thus, the database of the MSP 185 may be accessed to make these determinations and find potential solutions.

In addition, the NSA may consider further criteria. For example, in addition to the above considerations, the NSA may also consider the end user devices (e.g., the HSs 155, 170, 180, the MU 160, the laptop 165, and the desktop 175), the configurations of the end user devices such as operating system, software applications, etc. The database of the MSP 185 may also include further data. For example, with voice-over-wireless local are network (WLAN), the further data of the database may include partner voice application software, partner co-validation status per end user device, best practice WLAN configuration suggestions for deploying voice-over-WLAN, etc.

For a specific example such as IP telephony, the NSA may carry out an exemplary set of steps to determine a potential solution. The NSA may query the network 100 including the AP 145 and the switch 105 to detect real-time transport protocol (RTP) streams varying voice-over-IP traffic. By comparing call setup packet information to the database, the NSA may determine the telephony system that is deployed in the network 100 (e.g., Avaya). In addition, the NSA may detect from the network 100 an IP-private branch exchange (PBX) IP address. It should be noted that since the NSA incorporates the components of the network 100, the NSA may be required to incorporate the various operating systems that are supported by the end user devices (e.g., Windows Mobile 5, Windows PocketPC 2003, etc.). Thus, the NSA may use this data to select an appropriate version of the telephony system for each end user device as well as any supplementary software or configuration file(s) to make a potential solution.

Through cross-referencing the desired service against the above described criteria (e.g., partner co-validation matrix, network components, end user devices, partner voice software, best practice suggestions, etc.), the NSA may produce a report that includes recommendations of network hardware, end user hardware, partner software, and network configuration settings to provide the potential solution.

Returning to the method 200, in step 235, a determination is made whether the potential solutions require additional components. The NSA may cross reference the desired service with the network data (e.g., database) and may determine that the existing components of the network 100 cannot accommodate the service. However, the NSA may also determine that the service may be implemented upon inclusion of additional components to the network 100. For example, the desired service may require reaching a location that is not currently covered by the operating area of the network 100. The NSA may determine that placement of an additional AP at a particular location may accommodate the service. In another example, the NSA may determine that a new operating system or software application has to be installed on a network component in order to implement the solution.

If step 235 determines that additional components are required, the method 200 continues to step 270. In step 270, a prompt is displayed that indicates that additional components are required. The prompt may further display the potential solution upon inclusion of the additional components and may also indicate results such as a cost analysis, a benefit/detriment list, etc.

If step 235 determines that the existing components of the network 100 may accommodate the desired service, the method 200 continues to step 240. In step 240, the potential solutions are presented in, for example, a list (e.g., on display, printed, etc.). The list of potential solutions may include results of implementing the solution to achieve the desired service. For example, the results may include associated costs, a bandwidth analysis, a speed analysis, etc.

It should be noted that the method 200 may continue to both steps 240 and 270. For example, if the potential solutions include at least one solution that may accommodate the desired service with existing components and at least one solution that may accommodate the desired service with an inclusion of additional components, the prior type of solution may continue with step 240 while the latter type of solution may continue to step 270. An order in which to address the two types of solutions may be determined by the user or may be automatic (e.g., prior type is addressed before latter type).

In step 245, a determination is made whether to accept one of the potential solutions. Upon reviewing the potential solutions and/or the results associated with implementing the potential solutions, the user, system administrator, etc. may determine which solution is best suited for the network 100. If a solution is selected, the method 200 continues to step 265 where the NSA implements the solution to the network 100. The implementation of the new service may not be performed by the NSA, but the NSA may instruct other components to implement the service. For example, the NSA may indicate to the MSP 185 that additional software components are needed at various network devices. The MSP 185 may perform the requisite provisioning to provide the device with the software. In another example, the NSA may indicate to the MSP 185 that a functionality of a network device needs to be activated. The MSP 185 may alter a parameter value to activate the functionality and send this altered parameter to the desired device. Those skilled in the art will understand that there may be other manual and/or automatic steps that may be taken to implement the requested service and that the NSA as part of presenting the solution in step 240 may present all the steps that need to be taken to implement the solution.

It should be noted that because the NSA may determine multiple potential solutions for the desired service, multiple solutions may be implemented in step 265. For example, the user, system administrator, etc. may rank the potential solutions and may further include scenarios or conditions to implement the potential solutions to achieve a single desired service.

If the potential solutions are not accepted in step 245, the method 200 continues to step 250. In step 250, a determination is made whether to enter alterations to the potential solutions. For example, the potential solutions may include results that may be unacceptable for the network 100 (e.g., takes too much bandwidth, a component is not allowed to be used for a specific purpose, etc.). Thus, alterations to the potential solutions may be entered.

If no alterations are made and the potential solutions are unacceptable, then the method 200 ends. However, if alterations are made to the potential solutions, the method 200 continues to step 255. In step 255, a determination is made whether the alterations have changed the potential solution far enough that the desired service is no longer available. If step 255 determines that the service is no longer available, a prompt is displayed in step 260 indicating that the alterations have changed the solution such that it can no longer be implemented and providing the user with an additional prompt to make further alterations. The method 200 returns to step 250 to determine if other alterations are entered and to address the alterations that have been entered. If step 255 determines that the alterations do not change the solution so that the desired service is still available, the method 200 continues to step 265 where the solution is implemented.

It should be noted that the proposed solution may require selecting a specific type of software such as an operating system. That is, certain software programs may not be equipped to implement the new service. Thus, the network component may be required to install a new program or operating system. The proposed solution may indicate the software protocol to successfully implement the new service. Therefore, a system administrator may weigh advantages and disadvantages to determine whether implementing the new service is desirable. For example, each network component may be required to install the software to utilize the new service. The installation process may be lengthy and may require additional costs. However, the new service may provide users with a plurality of other functionalities.

It should also be noted that the implementation of a solution may entail an updating of software for end user devices. For example, a solution for implementing a new service may require a latest version of an operating system. That is, a prior version of an operating system may not be equipped to implement the proposed solution. Thus, upon implementing the new service, end user devices that require an update of software may be required to perform the update. The updating may be done manually by a user. That is, a prompt may be displayed on an end user device indicating that an update of software is required. The updating may also be done automatically. That is, once an end user device is connected to the network (or already connected), the software update may be performed. A prompt may be displayed to the user indicating that the update will be performed. The update of the software may also apply to any other network component of the network. That is, the servers, the APs, etc. may also require an update. The update of the software may be ascertained in a variety of manners. In a first example, a system administrator may forward the update to the network components that require the update. In another example, the database may be updated so that a network component may access the database to retrieve the update. In yet another example, the update may be available on the Internet so that a user may retrieve the update.

It should be noted that the NSA in conjunction with the MSP 185 may be equipped for an automatic provisioning of a selected solution. For example, the MSP 185 may push recommended and approved software, configure files and settings to end user devices and network components, implement suggestions with little or no manual intervention, etc.

Those skilled in the art will understand that the above described exemplary embodiments may be implemented in any number of manners, including, as a separate software module, as a combination of hardware and software, etc. For example, the NSA may be a program containing lines of code that, when compiled, may be executed on a processor.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A method, comprising:
receiving a request for a service to be implemented on a network;
determining at least one solution to implement the service utilizing existing network components of the network; and
presenting the at least one solution to a user.

2. The method of claim 1, wherein the network components are connected to the network using one of a wired connection, a wireless connection, and a combination thereof.

3. The method of claim 1, further comprising:
implementing one of the at least one solution.

4. The method of claim 1, further comprising:
presenting additional information relating to the at least one solution.

5. The method of claim 4, wherein the additional information relates to one of a speed, a cost, and a bandwidth of the solution.

6. The method of claim 1, further comprising:
interrogating at least one of network pathways, network components, and network end devices of the network to create network data, the network data including at least one of a network map, existing services, a network path for each of the existing services, at least one functionality for each of the network components, network component configurations, end user components, and end user component configurations.

7. The method of claim 6, wherein the determining includes searching the network data included in a database to determine the at least one solution.

8. The method of claim 1, further comprising:
comparing the at least one solution with a policy application to determine whether the solution is allowed to be implemented in the network.

9. The method of claim 1, further comprising:
receiving a selection of the at least one solution.

10. The method of claim 1, wherein the at least one solution includes adding a new network component to implement the requested service.

11. The method of claim 1, wherein the presenting includes one of displaying the at least one solution and printing the at least one solution.

12. The method of claim 1, wherein the at least one solution requires one of an installation of a new software and an update of an existing software, the new software and the update being retrieved from one of a database and an Internet.

13. A system, comprising:
a database storing network data for a plurality of network components in a network;
an input module receiving an input indicating a requested new service for the network;
a solution module searching the network data and determining at least one solution to implement the new service on the network; and
an output module presenting the at least one solution to a user.

14. The system of claim 13, wherein the network data includes one of a network map, existing services, a network path for each of the existing services, at least one functionality for each of the network components, network component configurations, end user components, and end user component configurations.

15. The system of claim 13, further comprising:
an interrogation module interrogating at least one of network pathways, network components, and network end devices of the network to create the network data.

16. The system of claim 13, wherein the input module includes a user interface including one of a list of services and a fillable form for entering the new service.

17. The system of claim 13, wherein the solution includes only existing network components.

18. The system of claim 13, wherein the solution includes additional components to be added to the network to implement the new service.

19. The system of claim 13, wherein the solution includes steps for implementing the new service.

20. The system of claim 13, further comprising:
a selection module receiving a selection of the solution by the user.

21. The system of claim 13, further comprising:
an implementation module providing information for the new service to be implemented on the network.

22. The system of claim 13, wherein the solution module determines additional information relating to the at least one solution and the output module presents the additional information to the user, the additional information relating to one of a speed, a cost, and a bandwidth of the solution.

23. The method of claim 13, further comprising:
a comparing module comparing the at least one solution with a policy application to determine whether the solution is allowed to be implemented in the network.

24. The system of claim 13, further comprising:
an alteration module receiving user alterations to the at least one solution.

25. The system of claim 13, wherein the at least one solution requires one of an installation of a new software and an update of an existing software, the new software and the update being retrieved from one of a database and an Internet.

26. A system, comprising:
a storage means for storing network data for a plurality of network components in a network;
an input means for receiving an input indicating a requested new service for the network;
a solution generating means for searching the network data and for determining at least one solution to implement the new service on the network; and
an output means for presenting the at least one solution to a user.

27. A computer readable storage medium including a set of instructions executable by a processor, the set of instructions operable to:
receive a request for a service to be implemented on a network;
determine at least one solution to implement the service utilizing existing network components of the network; and
present the at least one solution to a user.
